(19) United States
(12) Patent Application Publication
(10) Pub. No.: US 2018/0113871 A1
(43) Pub. Date: Apr. 26, 2018

(54) MAP EXTENT-BASED QUERYING FOR GEO-ENRICHED DATA

(71) Applicant: SAP SE, Walldorf (DE)

(72) Inventors: Jonathan Tiu, Surrey (CA); Xing Jin, Vancouver (CA); Sae-Won Om, Vancouver (CA)

(21) Appl. No.: 15/299,245

(22) Filed: Oct. 20, 2016

(51) Int. Cl. G06F 17/30

(52) U.S. Cl. CPC G06F 17/30061; G06F 17/30601; G06F 17/30241

(57) ABSTRACT

Some embodiments provide a non-transitory machine-readable medium that stores a program. The program receives from a client device a query for geo-enriched data and a map extent. The program further identifies a plurality of geo-enriched data based on the query. The program also stores the plurality of geo-enriched data. The program further determines a subset of the plurality of geo-enriched data based on the map extent. The program also provides the client device the subset of the plurality of geo-enriched data in order for the client device to render the map extent of a map that includes the subset of the plurality of geo-enriched data.

### BACKGROUND

Maps and mapping technology are used in many current computing and mobile applications and services. For example, some applications or services utilize mapping technology to provide navigation functions, location functions, traffic congestion functions, etc. Other applications or services may employ mapping technology to provide location-based search functions, social-networking functions, ride-sharing services, etc.

### SUMMARY

In some embodiments, a non-transitory machine-readable medium stores a program. The program receives from a client device a query for geo-enriched data and a map extent. The program further identifies a plurality of geo-enriched data based on the query. The program also stores the plurality of geo-enriched data. The program further determines a subset of the plurality of geo-enriched data based on the map extent. The program also provides the client device the subset of the plurality of geo-enriched data in order for the client device to render the map extent of a map that includes the subset of the plurality of geo-enriched data.

In some embodiments, the program further receives from the client device a clustering option for the geo-enriched data. Upon determining that the clustering option indicates to cluster the geo-enriched data, the program generates a set of spatial clusters. Each spatial cluster representing a portion of geo-enriched data in the subset of the plurality of geo-enriched data. Upon determining that the clustering option indicates to cluster the geo-enriched data, the program also provides the client device the set of spatial clusters instead of the portions of geo-enriched data in the subset of the plurality of geo-enriched data in order for the client device to render the map extent of the map that includes the set of spatial clusters and geo-enriched data other than the portions of geo-enriched data in the subset of the plurality of geo-enriched data.

In some embodiments, providing the client device the subset of the plurality of geo-enriched data includes providing the client device the subset of the plurality of geo-enriched data upon determining that the clustering option indicates not to cluster the geo-enriched data. In some embodiments, the clustering option specifies a threshold number of data points. The program further determines a number of geo-enriched data in the subset of the plurality of geo-enriched data. Generating the set of spatial clusters and providing the client device the set of spatial clusters are performed when the number of geo-enriched data in the subset of the plurality of geo-enriched data is greater than the threshold number of data points.

In some embodiments, determining the subset of the plurality of geo-enriched data includes performing a set of spatial operations on the plurality of geo-enriched data and the map extent. The query may be a first query and the plurality of geo-enriched data may be a first plurality of geo-enriched data. The program may further receive from the client device a second, different query for geo-enriched data and the map extent. The program may also identify a second plurality of geo-enriched data based on the second query. The program may further store the second plurality of geo-enriched data. The program may also determine a subset of the second plurality of geo-enriched data based on the map extent. The program may also provide the client device the subset of the second plurality of geo-enriched data in order for the client device to render the map extent of the map that includes the subset of the second plurality of geo-enriched data.

In some embodiments, the map extent is a first map extent and the subset of the plurality of geo-enriched data is a first subset of the plurality of geo-enriched data. The program may further receive from the client device the query for geo-enriched data and a second, different map extent. The program may also determine a second subset of the plurality of geo-enriched data based on the second map extent. The program may also provide the client device the second subset of the plurality of geo-enriched data in order for the client device to render the second map extent of the map that includes the second subset of the plurality of geo-enriched data.

In some embodiments, a method receives from a client device a query for geo-enriched data and a map extent. The method further identifies a plurality of geo-enriched data based on the query. The method also stores the plurality of geo-enriched data. The method further determines a subset of the plurality of geo-enriched data based on the map extent. The method also provides the client device the subset of the plurality of geo-enriched data in order for the client device to render the map extent of a map that includes the subset of the plurality of geo-enriched data.

In some embodiments, the method further receives from the client device a clustering option for the geo-enriched data. Upon determining that the clustering option indicates to cluster the geo-enriched data, the method generates a set of spatial clusters. Each spatial cluster representing a portion of geo-enriched data in the subset of the plurality of geo-enriched data. Upon determining that the clustering option indicates to cluster the geo-enriched data, the method also provides the client device the set of spatial clusters instead of the portions of geo-enriched data in the subset of the plurality of geo-enriched data in order for the client device to render the map extent of the map that includes the set of spatial clusters and geo-enriched data other than the portions of geo-enriched data in the subset of the plurality of geo-enriched data.

In some embodiments, providing the client device the subset of the plurality of geo-enriched data includes providing the client device the subset of the plurality of geo-enriched data upon determining that the clustering option indicates not to cluster the geo-enriched data. In some embodiments, the clustering option specifies a threshold number of data points. The method further determines a number of geo-enriched data in the subset of the plurality of geo-enriched data. Generating the set of spatial clusters and providing the client device the set of spatial clusters are performed when the number of geo-enriched data in the subset of the plurality of geo-enriched data is greater than the threshold number of data points.

In some embodiments, determining the subset of the plurality of geo-enriched data includes performing a set of spatial operations on the plurality of geo-enriched data and the map extent. The query may be a first query and the plurality of geo-enriched data may be a first plurality of geo-enriched data. The method may further receive from the client device a second, different query for geo-enriched data and the map extent. The method may also identify a second plurality of geo-enriched data based on the second query. The method may further store the second plurality of geo-enriched data. The method may also determine a subset of the second plurality of geo-enriched data based on the map extent. The method may further provide the client device the subset of the second plurality of geo-enriched data in order for the client device to render the map extent of the map that includes the subset of the second plurality of geo-enriched data.

In some embodiments, the map extent is a first map extent and the subset of the plurality of geo-enriched data is a first subset of the plurality of geo-enriched data. The method further receives from the client device the query for geo-enriched data and a second, different map extent. The method also determines a second subset of the plurality of geo-enriched data based on the second map extent. The method further provides the client device the second subset of the plurality of geo-enriched data in order for the client device to render the second map extent of the map that includes the second subset of the plurality of geo-enriched data.

In some embodiments, a system includes a set of processing units and a non-transitory computer-readable medium storing instructions. The instructions cause at least one processing unit to receive from a client device a query for geo-enriched data and a map extent. The instructions further cause at least one processing unit to identify a plurality of geo-enriched data based on the query. The instructions also cause at least one processing unit to store the plurality of geo-enriched data. The instructions further cause at least one processing unit to determine a subset of the plurality of geo-enriched data based on the map extent. The instructions also cause at least one processing unit to provide the client device the subset of the plurality of geo-enriched data in order for the client device to render the map extent of a map that includes the subset of the plurality of geo-enriched data.

In some embodiments, the instructions further cause the at least one processing unit to receive from the client device a clustering option for the geo-enriched data. Upon determining that the clustering option indicates to cluster the geo-enriched data, the instructions cause at least one processing unit to generate a set of spatial clusters. Each spatial cluster representing a portion of geo-enriched data in the subset of the plurality of geo-enriched data. Upon determining that the clustering option indicates to cluster the geo-enriched data, the instructions also cause at least one processing unit to provide the client device the set of spatial clusters instead of the portions of geo-enriched data in the subset of the plurality of geo-enriched data in order for the client device to render the map extent of the map that includes the set of spatial clusters and geo-enriched data other than the portions of geo-enriched data in the subset of the plurality of geo-enriched data. Providing the client device the subset of the plurality of geo-enriched data includes providing the client device the subset of the plurality of geo-enriched data upon determining that the clustering option indicates not to cluster the geo-enriched data.

In some embodiments, the clustering option specifies a threshold number of data points. The instructions further cause the at least one processing unit to determine a number of geo-enriched data in the subset of the plurality of geo-enriched data. Generating the set of spatial clusters and providing the client device the set of spatial clusters are performed when the number of geo-enriched data in the subset of the plurality of geo-enriched data is greater than the threshold number of data points. In some embodiments, determining the subset of the plurality of geo-enriched data includes performing a set of spatial operations on the plurality of geo-enriched data and the map extent.

In some embodiments, the query is a first query and the plurality of geo-enriched data is a first plurality of geo-enriched data. The instructions further cause the at least one processing unit to receive from the client device a second, different query for geo-enriched data and the map extent. The instructions also cause the at least one processing unit to identify a second plurality of geo-enriched data based on the second query. The instructions further cause the at least one processing unit to store the second plurality of geo-enriched data. The instructions also cause the at least one processing unit to determine a subset of the second plurality of geo-enriched data based on the map extent. The instructions further cause the at least one processing unit to provide the client device the subset of the second plurality of geo-enriched data in order for the client device to render the map extent of the map that includes the subset of the second plurality of geo-enriched data.

In some embodiments, the map extent is a first map extent and the subset of the plurality of geo-enriched data is a first subset of the plurality of geo-enriched data. The instructions further cause the at least one processing unit to receive from the client device the query for geo-enriched data and a second, different map extent. The instructions also cause the at least one processing unit to determine a second subset of the plurality of geo-enriched data based on the second map extent. The instructions further cause the at least one processing unit to provide the client device the second subset of the plurality of geo-enriched data in order for the client device to render the second map extent of the map that includes the second subset of the plurality of geo-enriched data.

The following detailed description and accompanying drawings provide a better understanding of the nature and advantages of the present invention.

### BRIEF DESCRIPTION OF THE DRAWINGS

FIG. 1 illustrates a system that includes a geo-enriched data system according to some embodiments.

FIG. 2 illustrates an example map visualization that includes a map extent according to some embodiments.

FIG. 3 illustrates an example map visualization that includes geo-enriched data according to some embodiments.

FIG. 4 illustrates a modified view of a map visualization according to some embodiments.

FIG. 5 illustrates an example map visualization that includes clustered geo-enriched data according to some embodiments.

FIG. 6 illustrates sub-clusters of clusters illustrated in FIG. 5 according to some embodiments.

FIG. 7 illustrates a process for providing geo-enriched data for a map extent according to some embodiments.

FIG. 8 illustrates an exemplary computer system, in which various embodiments may be implemented.

FIG. 9 illustrates an exemplary computing device, in which various embodiments may be implemented.

FIG. 10 illustrates system for implementing various embodiments described above.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Described herein are techniques for providing a system configured to process queries for geo-enriched data based on map extents. In some embodiments, the system receives such a query and a map extent from a client device. The system processes the query to identify geo-enriched data and stores the query results (i.e., the identified geo-enriched data) in the system. Based on the map extent, the system queries the stored query results to identify geo-enriched data that is within the map extent. The system then sends this data to the client device so that the client device may render the map extent on a display of the client device.

In some embodiments, geo-enriching data is associating non-location data with spatial data. For instance, data that includes non-location and location data associated with the non-location data may be geo-enriched by geocoding the location data. In some embodiments, geocoding location data is converting the location data to spatial data. In some embodiments, location data is data that describes a location, area, region, or combination thereof (e.g., a location, area, region, or combination thereof on Earth). Examples of location data may include address data, city data, state data, country data, postal zip code data, latitude and longitude data, etc., or a combination of any number of different types of location data (e.g., address data and city data, city data and state data, address data, etc.). In some embodiments, location data is textual data.

Spatial data may be data that defines the shape, size, position, and/or orientation of a geometry (e.g., a point, a line, an area, a region, or any combination thereof) in a defined space (e.g., the surface of the Earth). In some embodiments, a defined space in which geometries are defined is referred to as a spatial reference system (SRS). A particular defined space may be associated with a unique identifier referred to as a spatial reference identifier (SRID). Spatial data may be represented using a particular spatial data type (e.g., a point represented as an ST point, a line represented as an ST_curve, an area represented as an ST_polygon, etc.). Spatial operations may be performed on spatial data such as calculating the intersection of spatial data (e.g., intersection of two polygons), determining whether spatial data (e.g., a point, a line, a polygon, or any combination therefore) is contained within another spatial data (e.g., a polygon), etc.

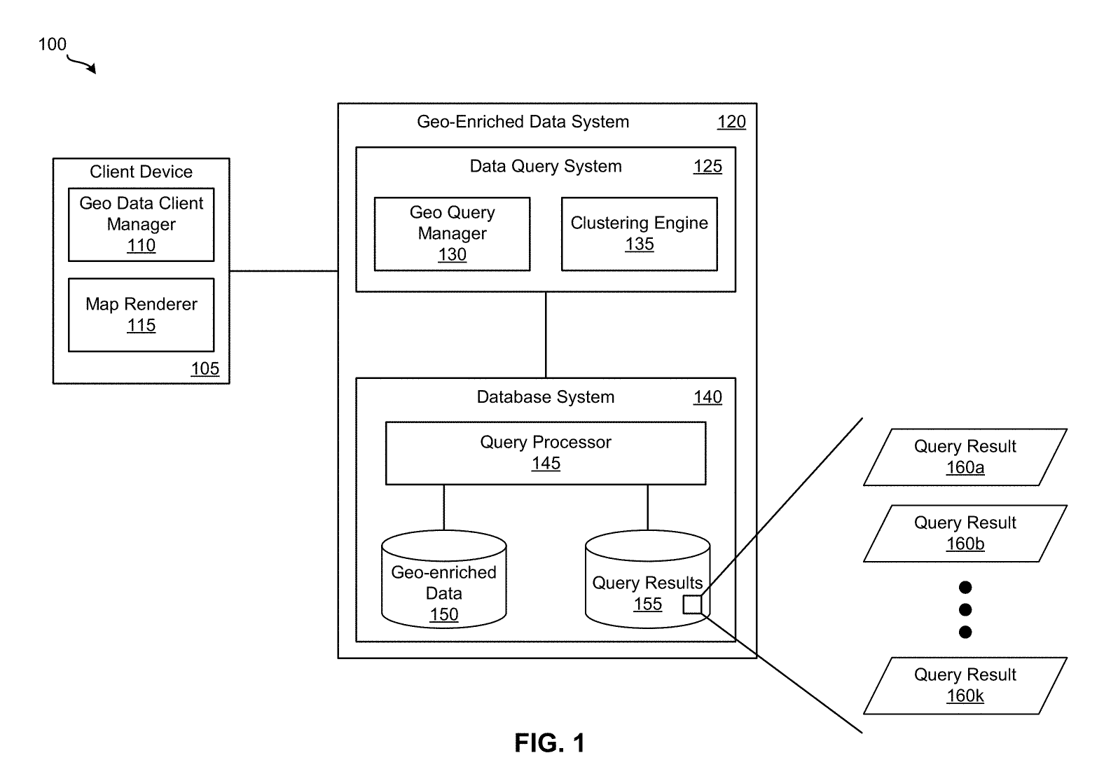

FIG. 1 illustrates a system 100 that includes a geo-enriched data system according to some embodiments. As shown, system 100 includes client device 105 and geo-enriched data system 120. Client device 105 is configured to access and communicate with geo-enriched data system 120 (e.g., via a network). As illustrated, client device 105 includes geo data client manager 110 and map renderer 115. In some embodiments, geo data client manager 110 and map rendered 115 may be implemented in an application (e.g., a web browser) operating on client device 105.

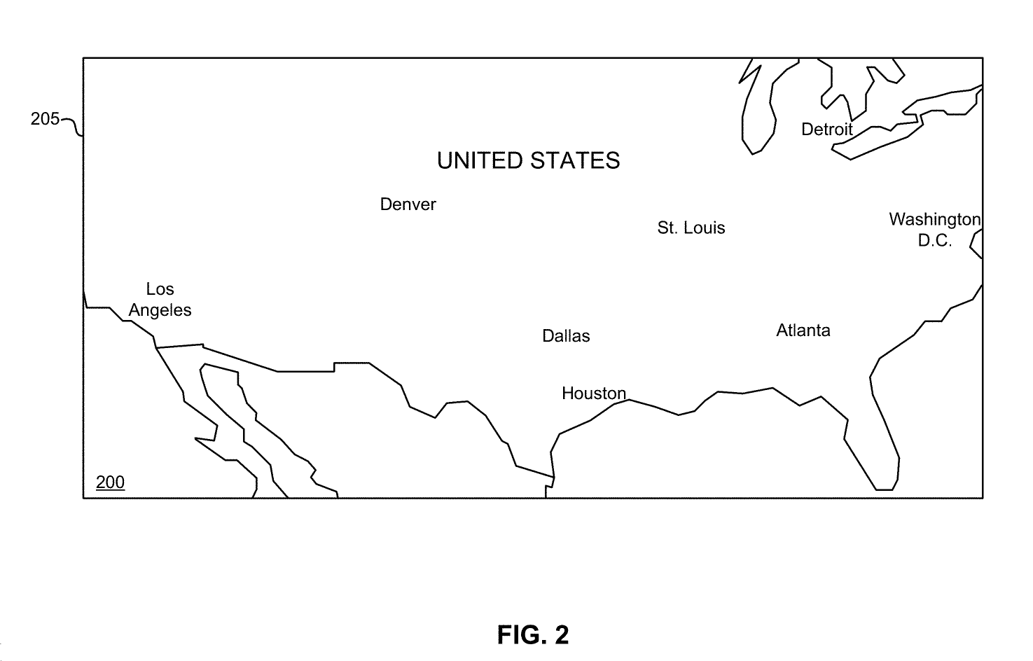

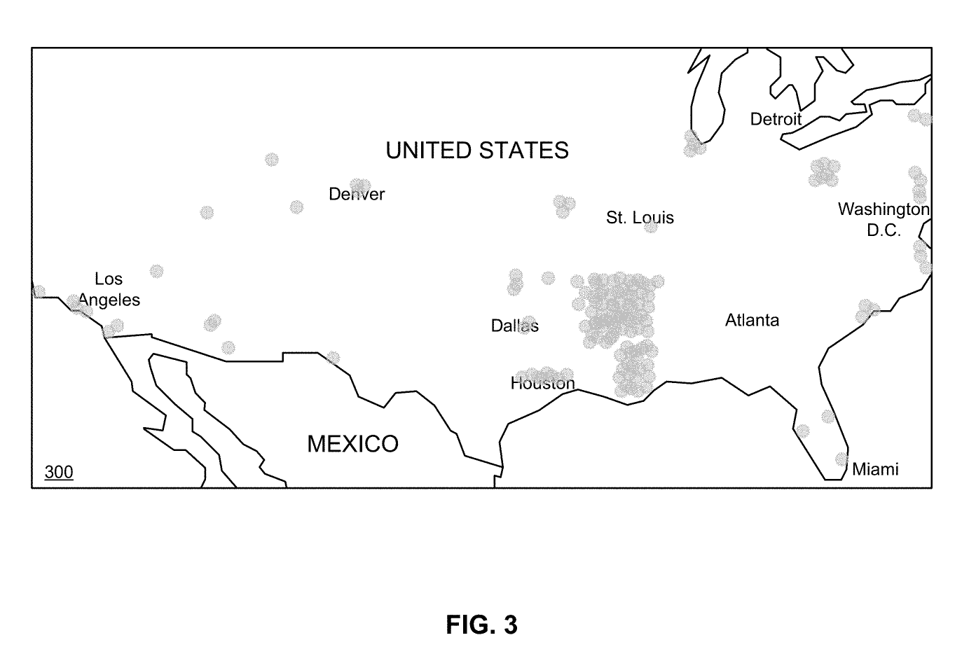

Geo data client manager 110 is configured to manage geo-enriched data for maps. For instance, geo data client manager 110 may send geo-enriched data system 120 a query for geo-enriched and a map extent. In some embodiments, a map extent is a defined region of a map. The geometry of the map extent may be specified using spatial data (e.g., an ST_polygon, a well-known text (WKT) polygon, etc.) in some such embodiments. FIG. 2 illustrates an example map visualization 200 that includes a map extent according to some embodiments. As illustrated, map visualization 200 includes map extent 205. In this example, map extent 205 defines a rectangular region that includes a large portion of the United States and a portion of Mexico. Upon receiving results from the query for geo-enriched data, geo data client manager 110 sends the geo-enriched data and the map extent to map renderer 115 for rendering. FIG. 3 illustrates an example map visualization that includes geo-enriched data according to some embodiments. In particular, FIG. 3 illustrates map visualization 200 that includes the geographical locations of stores in the United States. The locations of stores are represented by gray circles. Once geo data client manager 110 receives the map extent from map renderer 115, geo data client manager 110 displays the map extent on a display of client device 105.

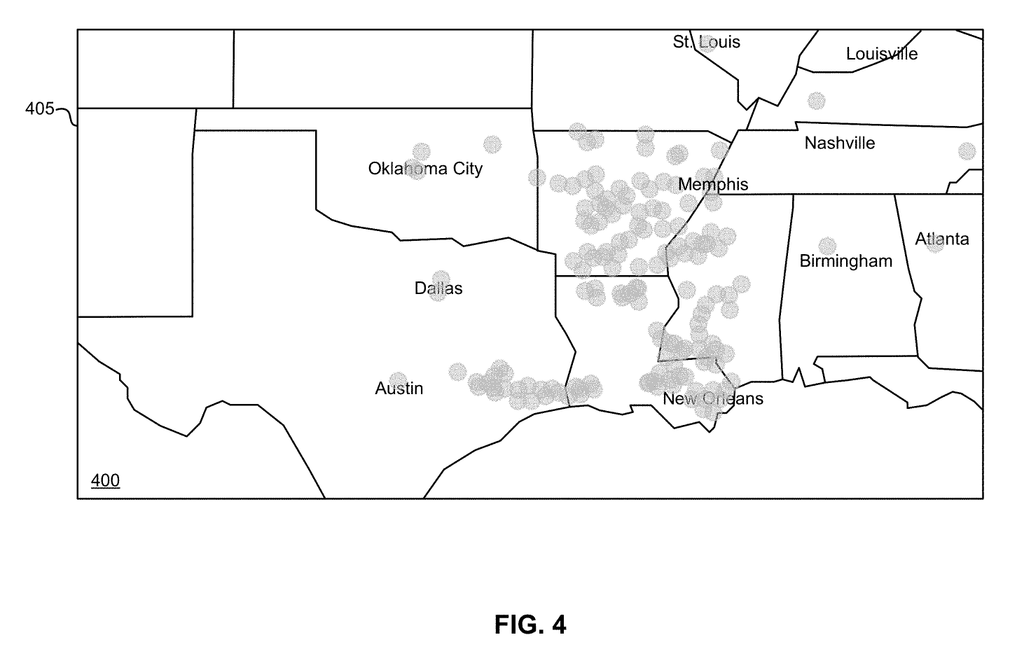

When a view of a map that includes the geo-enriched data is modified (e.g., panning, scrolling, zooming in, zooming out, etc.), geo data client manager 110 sends geo-enriched data system 120 a query for the geo-enriched data along with a map extent of the modified view of the map. After receiving results from geo-enriched data system 120, geo data client manager 110 sends the geo-enriched data and the map extent to map renderer 115 for rendering. As an example, FIG. 4 illustrates a modified view of a map visualization according to some embodiments. Specifically, FIG. 4 shows map visualization 400, which is a zoomed-in view of map visualization 200 illustrated in FIG. 3. As shown, map visualization 400 includes map extent 405, which defines a rectangular region that includes several states in the Southern United States (e.g., Texas, Oklahoma, Louisiana, Arkansas, Alabama, etc.). In addition, map visualization 400 includes the geographical locations of stores, which are represented by gray circles, in the shown portion of the United States.

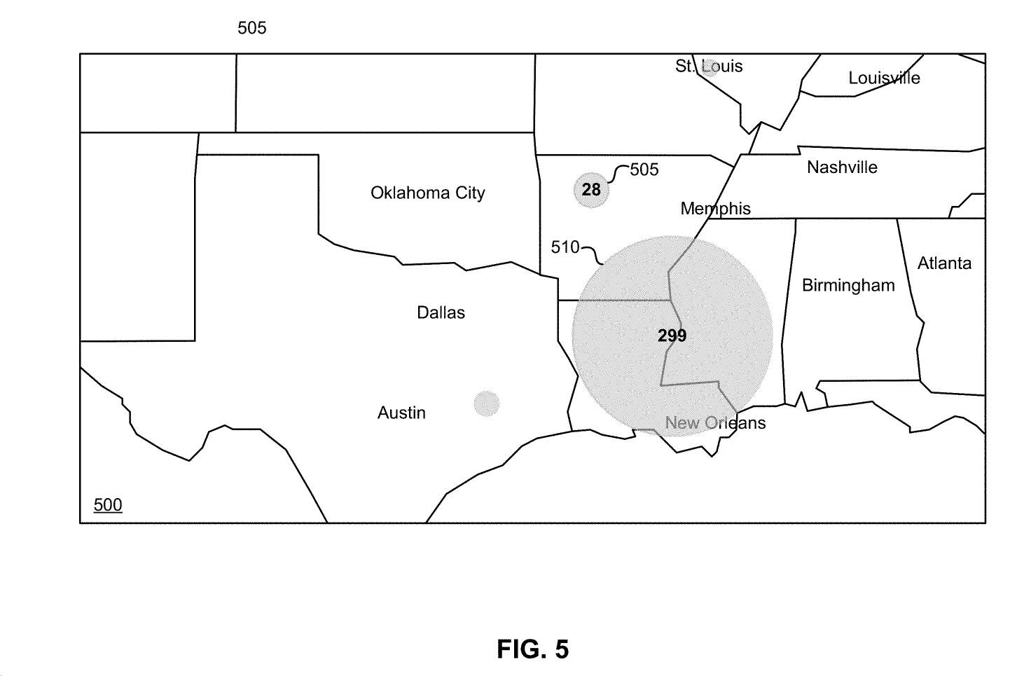

In some embodiments, geo data client manager 110 may send geo-enriched data system 120 a clustering option along with the query and the map extent. The clustering option may specify to cluster geo-enriched data and a threshold number of data points at which to cluster the geo-enriched data. When geo-enriched data is clustered, the geometries of portions of the geo-enriched data are represented by a single geometry (also referred to as a cluster geometry). The size and/or shape of a cluster geometry may be based on the number of geo-enriched data represented by the cluster geometry. FIG. 5 illustrates an example map visualization that includes clustered geo-enriched data according to some embodiments. Specifically, FIG. 5 illustrates map visualization 500 that includes clustered geo-enriched data shown in map visualization 400. As shown, various geographical location of stores in the Southern United States are clustered together and represented by clusters 505 and 510.

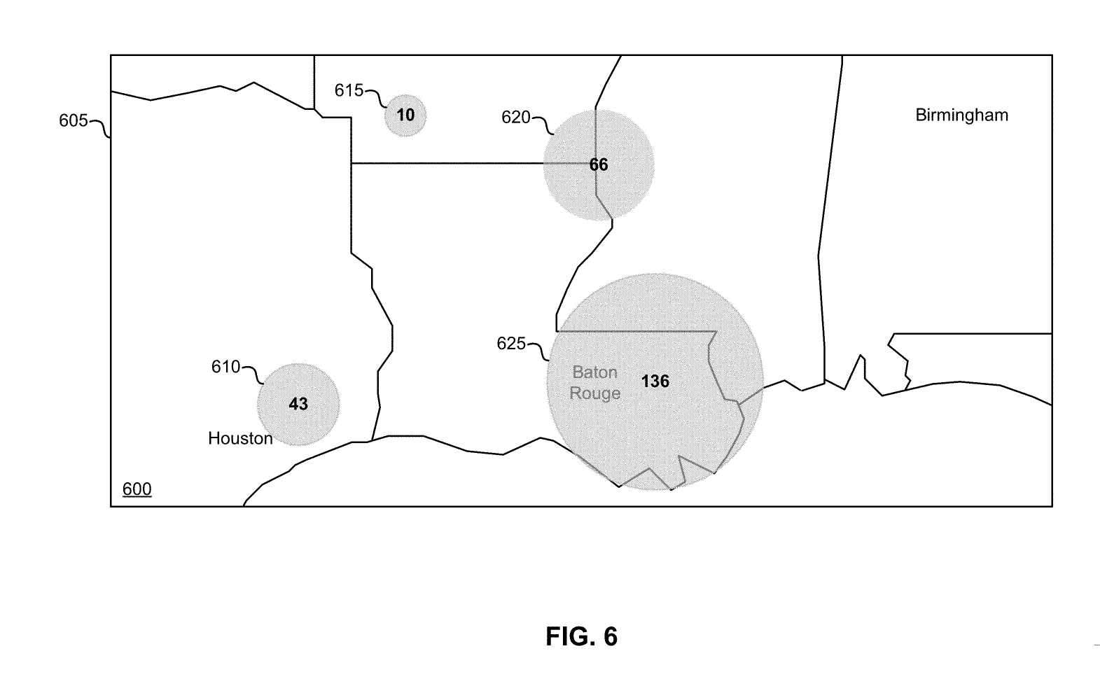

In some embodiments, client device 105 provides a feature for viewing the details of a cluster. For example, when a user of client device 105 causes a user interface (UI) indicator (e.g., a cursor) to hover over a cluster, client device 105 may display the geo-enriched data represented by the cluster. As another example, client device 105 may display the geo-enriched data represented by the cluster when client device 105 performs a zoom operation in response to input (e.g., selecting a zoom option, providing a touch-based pinch gesture, etc.) from a user. In some embodiments, client device 105 displays sub-clusters of the cluster instead of the geo-enriched data represented by the cluster. As an example, FIG. 6 illustrates sub-clusters of clusters illustrated in FIG. 5 according to some embodiments. Specifically, FIG. 6 illustrates map visualization 600, which is displayed after a zoom operation is performed on New Orleans in map visualization 500. As shown, map visualization 600 includes map extent 605, which defines a rectangular region surrounding New Orleans. Map visualization 600 also includes clusters 610-625. Clusters 615-625 are sub-clusters of cluster 510 shown in FIG. 5.

Map renderer 115 is responsible for rendering map extents of maps that include geo-enriched data. For example, map renderer 115 may receive from geo data client manager 110 geo-enriched data, a map extent, and a request to render the map extent that includes the geo-enriched data. In response to the request, map renderer 115 generates the map extent of a map that includes the geo-enriched data. Map renderer 115 then sends geo data client manager 110 the generated map extent.

As illustrated in FIG. 1, geo-enriched data system 120 includes data query system 125 and database system 140. In some embodiments, data query system 125 and database system 140 are implemented on single computing device while, in other embodiments, data query system 125 and database system 140 are implemented on separate computing devices. Data query system 125 and database system 140 may be implemented on a cloud computing system in some embodiments.

Data query system 125 is configured to handle queries for geo-enriched data from client device 105. As illustrated, data query system 125 includes geo query manager 130 and clustering engine 135. Geo query manager 130 receives queries for geo-enriched data and map extents from client device 105. When geo query manager 130 receives a query and a map extent from client device 105, geo query manager 130 sends the query to query processor 145 for processing. In return, geo query manager 130 receives from query processor 145 a reference to the results of the query. Geo query manager 130 then sends query processor 145 the reference to the results of the query, the map extent, and a request for geo-enriched data included in the map extent. Geo query manager 130 then receives from query processor 145 a subset of the geo-enriched data stored in the reference to the results of the query that are included in the map extent. Finally, geo query manager 130 sends the subset of the geo-enriched data to client device 105.

As mentioned above, client device 105 may send, in some embodiments, geo-enriched data system 120 a clustering option, which specifies to cluster geo-enriched data and a threshold number of data points at which to cluster the geo-enriched data, along with a query and a map extent. In some such embodiments, geo query manager 130 sends the subset of the geo-enriched data to clustering engine 135 instead of client device 105. In return, geo query manager 130 may receive from clustering engine 135 spatial clusters that each represents a portion of the subset of the geo-enriched data and any remaining geo-enriched data the subset of the geo-enriched data that was not clustered. In some instances, none of the subset of the geo-enriched data is clustered because the number of data in the subset of the geo-enriched data is less than the threshold number of data points specified in the clustering option. Geo query manager 130 sends the spatial clusters and the remaining geo-enriched data to client device 105.

Clustering engine 135 is configured to cluster geo-enriched data. In some embodiments, clustering engine 135 receives from geo query manager 130 geo-enriched data and a clustering option that specifies whether or not to cluster geo-enriched data and a threshold number of data points at which to cluster the geo-enriched data. Clustering engine 135 determines the number of data in the received geo-enriched data and compares it to the threshold number of data points specified in the clustering option. If the number of data in the received geo-enriched data is less than the threshold number of data points specified in the clustering option, clustering engine 135 does not perform any clustering on the geo-enriched data and sends geo query manager 130 a notification indicating so. Otherwise, clustering engine 135 performs a clustering technique on the geo-enriched data. Clustering engine 135 utilizes any number of different clustering techniques in different embodiments. For instance, in some embodiments, clustering engine 135 uses a grid-based clustering technique. In other embodiments, clustering engine may use a k-means clustering technique. After clustering the geo-enriched data, clustering engine 135 sends the clustered geo-enriched data to geo query manager 130.

Database system 140 is responsible for managing geo-enriched data stored in database system 140. As shown, database system 140 includes query processor 145, geo-enriched data storage 150, and query results storage 155. Geo-enriched data storage 150 is configured to store geo-enriched data. Query results storage 155 is configured to store results of queries for geo-enriched data stored in geo-enriched data storage 150. In some embodiments, storages 150 and 155 are implemented in a single physical storage while, in other embodiments, storages 150 and 155 may be implemented across several physical storages. While FIG. 1 shows storages 150 and 155 included in database system 140, one of ordinary skill in the art will appreciated that storages 150 and/or 155 may be external to database system 140 in some embodiments.

Query processor 145 processes queries received from geo query manager 130. For instance, when query processor 145 receives a query (e.g., a structured query language (SQL) query) for geo-enriched data from geo query manager 130, query processor accesses geo-enriched data storage 150 and identifies geo-enriched data based on the query. Next, query processor 145 stores the query results (i.e., the identified geo-enriched data) in query results storage 155 for later use. Query processor 145 then sends geo query manager 130 a notification that the query has been processed as well as a reference to the stored query results (e.g., a name of a of table in query results storage 155 that stores the query results). Query processor 145 stores different query results in query results storage 155 for different queries. As shown in FIG. 1, query results storage 155 stores different query results 160a-k in this example. If query processor 145 receives a query from geo query manager 130 that already has results stored in query results storage 155, query processor 145 does not process the query again. Instead, query processor 145 sends geo query manager 130 the reference to the stored query results.

In some embodiments, query processor 145 may receive a reference to results of a query stored in query results storage 155, a map extent, and a request for geo-enriched data included in the map extent. To process the request, query processor 145 performs a spatial operation on the geo-enriched data stored in the reference to the results of the query and the map extent. In some embodiments, the spatial operation determines a subset of the geo-enriched data stored in the reference to the results of the query that are contained in the geometry of the map extent. Query processor 145 then sends the subset of the geo-enriched data to geo query manager 130.

FIG. 1 illustrates a system that includes a client device and a geo-enriched data system. One of ordinary skill in the art will understand that the system may include any number of additional client devices that are configured to interact with the geo-enriched data system in the same or similar manner as that described above by reference to client device 105.

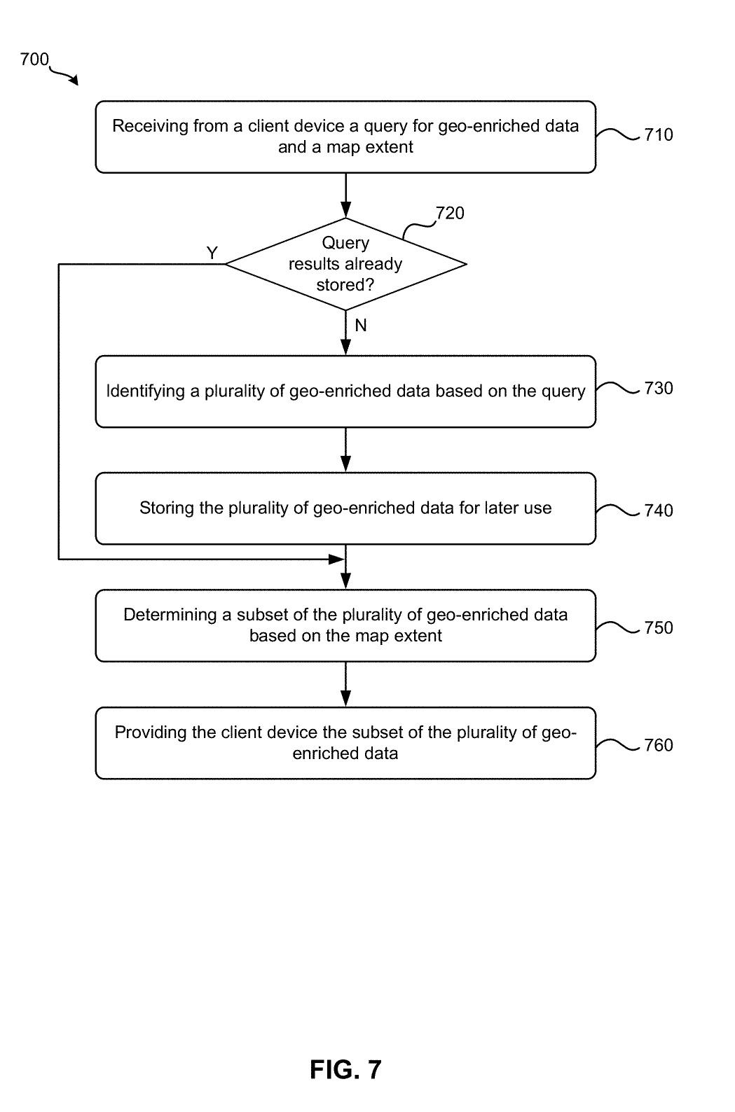

FIG. 7 illustrates a process 700 for providing geo-enriched data for a map extent according to some embodiments. In some embodiments, geo-enriched data system 120 performs process 700. Process 700 starts by receiving, at 710, from a client device (e.g., client device 105) a query for geo-enriched data and a map extent. In some embodiments, process 700 may also receive from the client device a clustering option that specifies to cluster the geo-enriched data and a threshold number of data points at which to cluster the geo-enriched data.

Next, process 700 determines, at 720, whether query results for the query are already stored. As described above, when query processor 145 receives a query from geo query manager 130 that already has results stored in query results storage 155, query processor 145 does not process the query again. As such, when process 700 determines that the query results for the query are already stored, process 700 proceeds to operation 750. Otherwise, process 700 continues to operation 730.

At 730, process 700 identifies a plurality of geo-enriched data based on the query. In some embodiments, process 700 identifies the plurality of geo-enriched data by accessing geo-enriched data storage 150 and retrieving the plurality of geo-enriched data. Process 700 then stores, at 740, the plurality of geo-enriched data for later use. In some embodiments, process 700 stores the plurality of geo-enriched data in query results storage 155.

Next, process 700 identifies, at 750, a subset of the plurality of geo-enriched data based on the map extent. In some embodiments, process 700 identifies the subset of the plurality of geo-enriched data by performing a spatial operation that determines geo-enriched data that are contained in the geometry of the map extent. As explained above, process 700 may also receive from the client device a clustering option that specifies to cluster the geo-enriched data and a threshold number of data points at which to cluster the geo-enriched data in some embodiments. In some such embodiments, process 700 determines the number of data in the subset of the plurality of geo-enriched data and compares it to the threshold number of data points specified in the clustering option. If the number of data in the subset of the plurality of geo-enriched data is less than the threshold number of data points specified in the clustering option, process 700 does not perform any clustering on the subset of the plurality of geo-enriched data. If the number of data in the subset of the plurality of geo-enriched data is greater than or equal to the threshold number of data points specified in the clustering option, process 700 performs a clustering technique on the subset of the plurality of geo-enriched data.

Finally, process 700 provides, at 760, the client device the subset of the plurality of geo-enriched data so the client device may render the map extent of a map that includes the subset of the plurality of geo-enriched data. If the subset of the plurality of geo-enriched data has been clustered, process 700 provides the client device the clustered geo-enriched data and any remaining geo-enriched data that is not clustered.

In some embodiments, geo-enriched data system 120 may not store query results in database system 140. Rather, when geo-enriched data system 120 receives a query for geo-enriched data from client device 105 in some such embodiments, geo query manager 130 sends the query to database system 140 for processing, database system 140 returns the query results to geo query manager 130, and geo query manager 130 sends client device 105 the query results. That is, geo-enriched data system 120 provides client device 105 all of the geo-enriched data in the query results instead of just the geo-enriched data in the query results that are included in a map extent. When client device 105 receives the query results, map renderer 115 renders a map that includes the geo-enriched data in the query results and displays a map extent of the map.

In some embodiments where geo-enriched data system 120 provides client device 105 all of the geo-enriched data in the query results, the clustering operations described above are implemented on client device 105 instead of geo-enriched data system 120. In some such embodiments, client device 105 includes a clustering engine that implements the same or similar functions described above by reference to clustering engine 135. If a clustering option is enabled, client device 105 clusters the geo-enriched data in the same or similar manner described above and map renderer 115 renders a map that includes the clustered geo-enriched data and any remaining geo-enriched data that is not clustered and displays a map extent of the map.

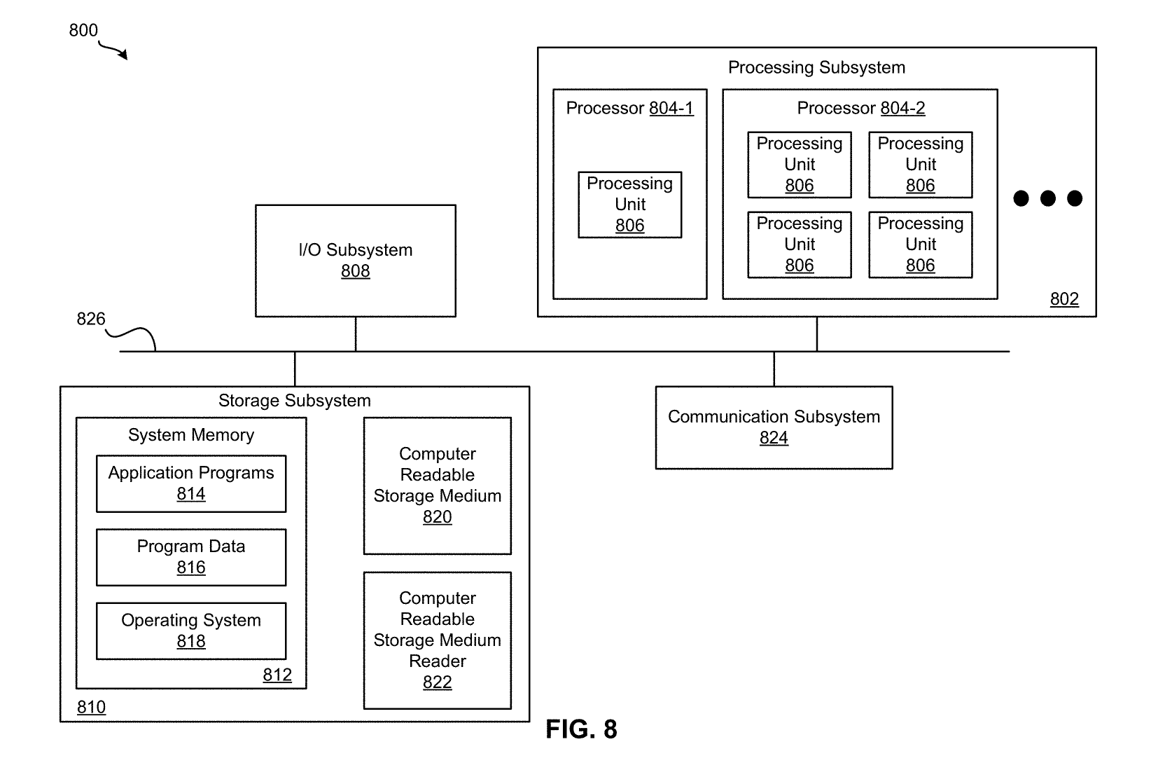

FIG. 8 illustrates an exemplary computer system 800, in which various embodiments may be implemented. For example, computer system 800 may be used to implement client device 105 and geo-enriched data system 120. Computer system 800 may be a desktop computer, a laptop, a server computer, or any other type of computer system or combination thereof. Some or all elements of geo-enriched data system 120, or combinations thereof can be included or implemented in computer system 800. In addition, computer system 800 can implement many of the operations, methods, and/or processes described above (e.g., process 700). As shown in FIG. 8, computer system 800 includes processing subsystem 802, which communicates, via bus subsystem 826, with input/output (I/O) subsystem 808, storage subsystem 810 and communication subsystem 824.

Bus subsystem 826 is configured to facilitate communication among the various components and subsystems of computer system 800. While bus subsystem 826 is illustrated in FIG. 8 as a single bus, one of ordinary skill in the art will understand that bus subsystem 826 may be implemented as multiple buses. Bus subsystem 826 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 802, which can be implemented as one or more integrated circuits (e.g., a conventional microprocessor or microcontroller), controls the operation of computer system 800. Processing subsystem 802 may include one or more processors 804. Each processor 804 may include one processing unit 806 (e.g., a single core processor such as processor 804-1) or several processing units 806 (e.g., a multicore processor such as processor 804-2). In some embodiments, processors 804 of processing subsystem 802 may be implemented as independent processors while, in other embodiments, processors 804 of processing subsystem 802 may be implemented as multiple processors integrate into a single chip or multiple chips. Still, in some embodiments, processors 804 of processing subsystem 802 may be implemented as a combination of independent processors and multiple processors integrated into a single chip or multiple chips.

In some embodiments, processing subsystem 802 can execute a variety of programs or processes in response to program code and can maintain multiple concurrently executing programs or processes. At any given time, some or all of the program code to be executed can reside in processing subsystem 802 and/or in storage subsystem 810. Through suitable programming, processing subsystem 802 can provide various functionalities, such as the functionalities described above by reference to process 700, etc.

I/O subsystem 808 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 800 to a user or another device (e.g., a printer).

As illustrated in FIG. 8, storage subsystem 810 includes system memory 812, computer-readable storage medium 820, and computer-readable storage medium reader 822. System memory 812 may be configured to store software in the form of program instructions that are loadable and executable by processing subsystem 802 as well as data generated during the execution of program instructions. In some embodiments, system memory 812 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 812 may include different types of memory, such as static random access memory (SRAM) and/or dynamic random access memory (DRAM). System memory 812 may include a basic input/output system (BIOS), in some embodiments, that is configured to store basic routines to facilitate transferring information between elements within computer system 800 (e.g., during start-up). Such a BIOS may be stored in ROM (e.g., a ROM chip), flash memory, or any other type of memory that may be configured to store the BIOS.

As shown in FIG. 8, system memory 812 includes application programs 814, program data 816, and operating system (OS) 818. OS 818 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 820 may be a non-transitory computer-readable medium configured to store software (e.g., programs, code modules, data constructs, instructions, etc.). Many of the components (e.g., geo data client manager 110, map renderer 115, geo query manager 130, clustering engine 135, and query processor 145) and/or processes (e.g., process 700) described above may be implemented as software that when executed by a processor or processing unit (e.g., a processor or processing unit of processing subsystem 802) performs the operations of such components and/or processes. Storage subsystem 810 may also store data used for, or generated during, the execution of the software.

Storage subsystem 810 may also include computer-readable storage medium reader 822 that is configured to communicate with computer-readable storage medium 820. Together and, optionally, in combination with system memory 812, computer-readable storage medium 820 may comprehensively represent remote, local, fixed, and/or removable storage devices plus storage media for temporarily and/or more permanently containing, storing, transmitting, and retrieving computer-readable information.

Computer-readable storage medium 820 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 824 serves as an interface for receiving data from, and transmitting data to, other devices, computer systems, and networks. For example, communication subsystem 824 may allow computer system 800 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 824 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 824 may provide components configured for wired communication (e.g., Ethernet) in addition to or instead of components configured for wireless communication.

One of ordinary skill in the art will realize that the architecture shown in FIG. 8 is only an example architecture of computer system 800, and that computer system 800 may have additional or fewer components than shown, or a different configuration of components. The various components shown in FIG. 8 may be implemented in hardware, software, firmware or any combination thereof, including one or more signal processing and/or application specific integrated circuits.

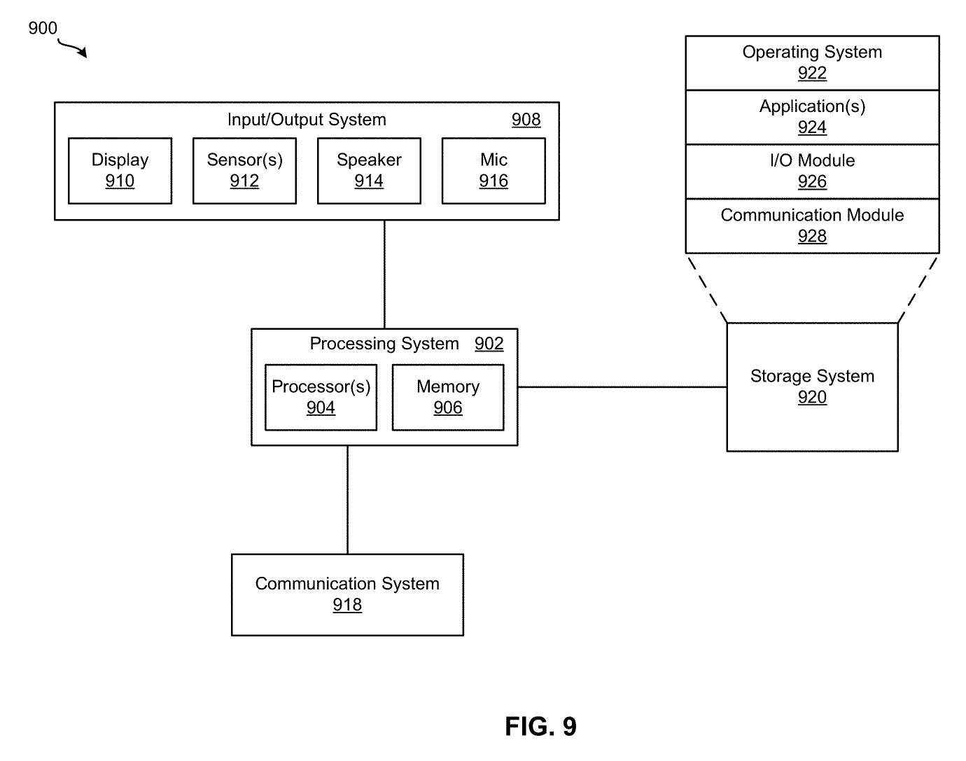

FIG. 9 illustrates an exemplary computing device 900, in which various embodiments may be implemented. For example, computing device 900 may be used to implement client device 105. Computing device 900 may be a cellphone, a smartphone, a wearable device, an activity tracker or manager, a tablet, a personal digital assistant (PDA), a media player, or any other type of mobile computing device or combination thereof. Some or all elements of client device 105, or combinations thereof can be included or implemented in computing device 900. As shown in FIG. 9, computing device 900 includes processing system 902, input/output (I/O) system 908, communication system 918, and storage system 920. These components may be coupled by one or more communication buses or signal lines.

Processing system 902, which can be implemented as one or more integrated circuits (e.g., a conventional microprocessor or microcontroller), controls the operation of computing device 900. As shown, processing system 902 includes one or more processors 904 and memory 906. Processors 904 are configured to run or execute various software and/or sets of instructions stored in memory 906 to perform various functions for computing device 900 and to process data.

Each processor of processors 904 may include one processing unit (e.g., a single core processor) or several processing units (e.g., a multicore processor). In some embodiments, processors 904 of processing system 902 may be implemented as independent processors while, in other embodiments, processors 904 of processing system 902 may be implemented as multiple processors integrate into a single chip. Still, in some embodiments, processors 904 of processing system 902 may be implemented as a combination of independent processors and multiple processors integrated into a single chip.

Memory 906 may be configured to receive and store software (e.g., operating system 922, applications 924, I/O module 926, communication module 928, etc. from storage system 920) in the form of program instructions that are loadable and executable by processors 904 as well as data generated during the execution of program instructions. In some embodiments, memory 906 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 908 is responsible for receiving input through various components and providing output through various components. As shown for this example, I/O system 908 includes display 910, one or more sensors 912, speaker 914, and microphone 916. Display 910 is configured to output visual information (e.g., a graphical user interface (GUI) generated and/or rendered by processors 904). In some embodiments, display 910 is a touch screen that is configured to also receive touch-based input. Display 910 may be implemented using liquid crystal display (LCD) technology, light-emitting diode (LED) technology, organic LED (OLED) technology, organic electro luminescence (OEL) technology, or any other type of display technologies. Sensors 912 may include any number of different types of sensors for measuring a physical quantity (e.g., temperature, force, pressure, acceleration, orientation, light, radiation, etc.). Speaker 914 is configured to output audio information and microphone 916 is configured to receive audio input. One of ordinary skill in the art will appreciate that I/O system 908 may include any number of additional, fewer, and/or different components. For instance, I/O system 908 may include a keypad or keyboard for receiving input, a port for transmitting data, receiving data and/or power, and/or communicating with another device or component, an image capture component for capturing photos and/or videos, etc.

Communication system 918 serves as an interface for receiving data from, and transmitting data to, other devices, computer systems, and networks. For example, communication system 918 may allow computing device 900 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 918 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 918 may provide components configured for wired communication (e.g., Ethernet) in addition to or instead of components configured for wireless communication.

Storage system 920 handles the storage and management of data for computing device 900. Storage system 920 may be implemented by one or more non-transitory machine-readable mediums that are configured to store software (e.g., programs, code modules, data constructs, instructions, etc.) and store data used for, or generated during, the execution of the software. Many of the components (e.g., geo data client manager 110 and map renderer 115) described above may be implemented as software that when executed by a processor or processing unit (e.g., processors 904 of processing system 902) performs the operations of such components and/or processes.

In this example, storage system 920 includes operating system 922, one or more applications 924, I/O module 926, and communication module 928. Operating system 922 includes various procedures, sets of instructions, software components and/or drivers for controlling and managing general system tasks (e.g., memory management, storage device control, power management, etc.) and facilitates communication between various hardware and software components. Operating system 922 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 924 can include any number of different applications installed on computing device 900. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 926 manages information received via input components (e.g., display 910, sensors 912, and microphone 916) and information to be outputted via output components (e.g., display 910 and speaker 914). Communication module 928 facilitates communication with other devices via communication system 918 and includes various software components for handling data received from communication system 918.

One of ordinary skill in the art will realize that the architecture shown in FIG. 9 is only an example architecture of computing device 900, and that computing device 900 may have additional or fewer components than shown, or a different configuration of components. The various components shown in FIG. 9 may be implemented in hardware, software, firmware or any combination thereof, including one or more signal processing and/or application specific integrated circuits.

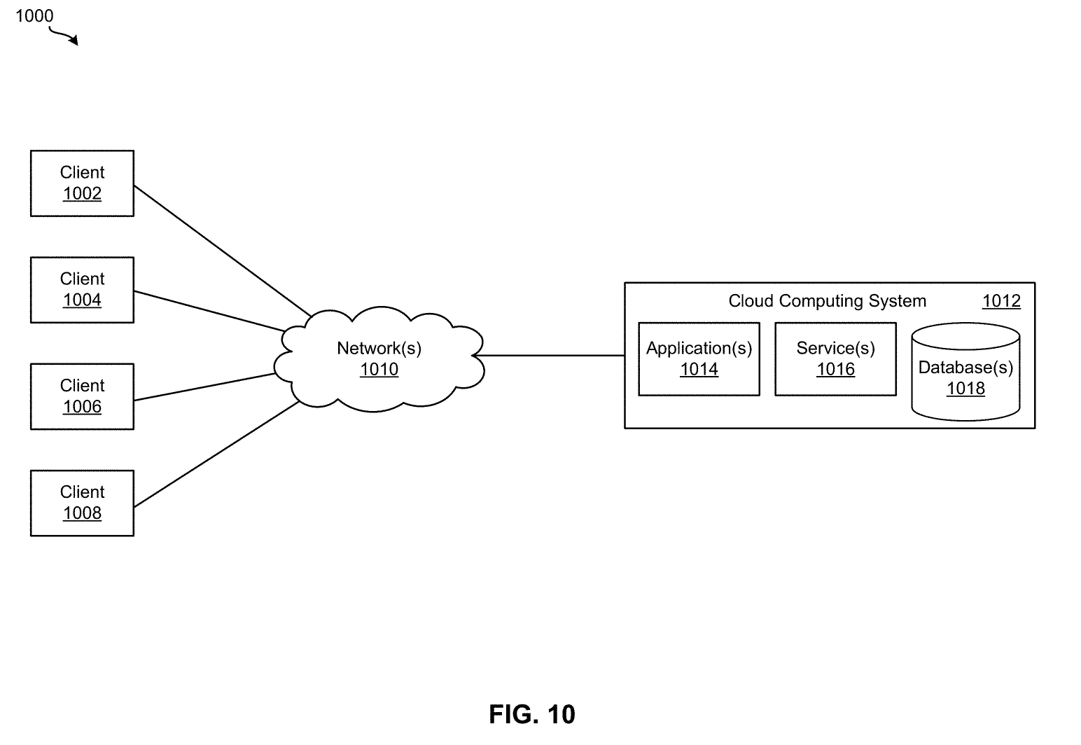

FIG. 10 illustrates system 1000 for implementing various embodiments described above. For example, cloud computing system 1012 of system 1000 may be used to implement geo-enriched data system 120 and one of the clients 1002-1008 may be used to implement client device 105. As shown, system 1000 includes client devices 1002-1008, one or more networks 1010, and cloud computing system 1012. Cloud computing system 1012 is configured to provide resources and data to client devices 1002-1008 via networks 1010. In some embodiments, cloud computing system 1000 provides resources to any number of different users (e.g., customers, tenants, organizations, etc.). Cloud computing system 1012 may be implemented by one or more computer systems (e.g., servers), virtual machines operating on a computer system, or a combination thereof.

As shown, cloud computing system 1012 includes one or more applications 1014, one or more services 1016, and one or more databases 1018. Cloud computing system 1000 may provide applications 1014, services 1016, and databases 1018 to any number of different customers in a self-service, subscription-based, elastically scalable, reliable, highly available, and secure manner.

In some embodiments, cloud computing system 1000 may be adapted to automatically provision, manage, and track a customer's subscriptions to services offered by cloud computing system 1000. Cloud computing system 1000 may provide cloud services via different deployment models. For example, cloud services may be provided under a public cloud model in which cloud computing system 1000 is owned by an organization selling cloud services and the cloud services are made available to the general public or different industry enterprises. As another example, cloud services may be provided under a private cloud model in which cloud computing system 1000 is operated solely for a single organization and may provide cloud services for one or more entities within the organization. The cloud services may also be provided under a community cloud model in which cloud computing system 1000 and the cloud services provided by cloud computing system 1000 are shared by several organizations in a related community. The cloud services may also be provided under a hybrid cloud model, which is a combination of two or more of the aforementioned different models.

In some instances, any one of applications 1014, services 1016, and databases 1018 made available to client devices 1002-1008 via networks 1010 from cloud computing system 1000 is referred to as a “cloud service.” Typically, servers and systems that make up cloud computing system 1000 are different from the on-premises servers and systems of a customer. For example, cloud computing system 1000 may host an application and a user of one of client devices 1002-1008 may order and use the application via networks 1010.

Applications 1014 may include software applications that are configured to execute on cloud computing system 1012 (e.g., a computer system or a virtual machine operating on a computer system) and be accessed, controlled, managed, etc. via client devices 1002-1008. In some embodiments, applications 1014 may include server applications and/or mid-tier applications (e.g., HTTP (hypertext transport protocol) server applications, FTP (file transfer protocol) server applications, CGI (common gateway interface) server applications, JAVA server applications, etc.). Services 1016 are software components, modules, application, etc. that are configured to execute on cloud computing system 1012 and provide functionalities to client devices 1002-1008 via networks 1010. Services 1016 may be web-based services or on-demand cloud services.

Databases 1018 are configured to store and/or manage data that is accessed by applications 1014, services 1016, and/or client devices 1002-1008. For instance, storages 150 and 155 may be stored in databases 1018. Databases 1018 may reside on a non-transitory storage medium local to (and/or resident in) cloud computing system 1012, in a storage-area network (SAN), on a non-transitory storage medium local located remotely from cloud computing system 1012. In some embodiments, databases 1018 may include relational databases that are managed by a relational database management system (RDBMS). Databases 1018 may be a column-oriented databases, row-oriented databases, or a combination thereof. In some embodiments, some or all of databases 1018 are in-memory databases. That is, in some such embodiments, data for databases 1018 are stored and managed in memory (e.g., random access memory (RAM)).

Client devices 1002-1008 are configured to execute and operate a client application (e.g., a web browser, a proprietary client application, etc.) that communicates with applications 1014, services 1016, and/or databases 1018 via networks 1010. This way, client devices 1002-1008 may access the various functionalities provided by applications 1014, services 1016, and databases 1018 while applications 1014, services 1016, and databases 1018 are operating (e.g., hosted) on cloud computing system 1000. Client devices 1002-1008 may be computer system 800 or computing device 900, as described above by reference to FIGS. 8 and 9, respectively. Although system 1000 is shown with four client devices, any number of client devices may be supported.

Networks 1010 may be any type of network configured to facilitate data communications among client devices 1002-1008 and cloud computing system 1012 using any of a variety of network protocols. Networks 1010 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A non-transitory machine-readable medium storing a program executable by at least one processing unit of a computing device, the program comprising sets of instructions for:
receiving from a client device a query for geo-enriched data and a map extent;
identifying a plurality of geo-enriched data based on the query;
storing the plurality of geo-enriched data;
determining a subset of the plurality of geo-enriched data based on the map extent; and
providing the client device the subset of the plurality of geo-enriched data in order for the client device to render the map extent of a map comprising the subset of the plurality of geo-enriched data.

2. The non-transitory machine-readable medium of claim 1, wherein the program further comprises sets of instructions for:
receiving from the client device a clustering option for the geo-enriched data;
upon determining that the clustering option indicates to cluster the geo-enriched data:
generating a set of spatial clusters, each spatial cluster representing a portion of geo-enriched data in the subset of the plurality of geo-enriched data; and
providing the client device the set of spatial clusters instead of the portions of geo-enriched data in the subset of the plurality of geo-enriched data in order for the client device to render the map extent of the map comprising the set of spatial clusters and geo-enriched data other than the portions of geo-enriched data in the subset of the plurality of geo-enriched data.

3. The non-transitory machine-readable medium of claim 2, wherein providing the client device the subset of the plurality of geo-enriched data comprises providing the client device the subset of the plurality of geo-enriched data upon determining that the clustering option indicates not to cluster the geo-enriched data.

4. The non-transitory machine-readable medium of claim 2, wherein the clustering option specifies a threshold number of data points, wherein the program further comprises a set of instructions for determining a number of geo-enriched data in the subset of the plurality of geo-enriched data, wherein generating the set of spatial clusters and providing the client device the set of spatial clusters are performed when the number of geo-enriched data in the subset of the plurality of geo-enriched data is greater than the threshold number of data points.

5. The non-transitory machine-readable medium of claim 1, wherein determining the subset of the plurality of geo-enriched data comprises performing a set of spatial operations on the plurality of geo-enriched data and the map extent.

6. The non-transitory machine-readable medium of claim 1, wherein the query is a first query, wherein the plurality of geo-enriched data is a first plurality of geo-enriched data, wherein the program further comprises sets of instructions for:
receiving from the client device a second, different query for geo-enriched data and the map extent;
identifying a second plurality of geo-enriched data based on the second query;
storing the second plurality of geo-enriched data;
determining a subset of the second plurality of geo-enriched data based on the map extent; and
providing the client device the subset of the second plurality of geo-enriched data in order for the client device to render the map extent of the map comprising the subset of the second plurality of geo-enriched data.

7. The non-transitory machine-readable medium of claim 1, wherein the map extent is a first map extent, wherein the subset of the plurality of geo-enriched data is a first subset of the plurality of geo-enriched data, wherein the program further comprises sets of instructions for:
receiving from the client device the query for geo-enriched data and a second, different map extent;
determining a second subset of the plurality of geo-enriched data based on the second map extent; and
providing the client device the second subset of the plurality of geo-enriched data in order for the client device to render the second map extent of the map comprising the second subset of the plurality of geo-enriched data.

8. A method comprising:
receiving from a client device a query for geo-enriched data and a map extent;
identifying a plurality of geo-enriched data based on the query;
storing the plurality of geo-enriched data;
determining a subset of the plurality of geo-enriched data based on the map extent; and
providing the client device the subset of the plurality of geo-enriched data in order for the client device to render the map extent of a map comprising the subset of the plurality of geo-enriched data.

9. The method of claim 8 further comprising:
receiving from the client device a clustering option for the geo-enriched data;
upon determining that the clustering option indicates to cluster the geo-enriched data:
generating a set of spatial clusters, each spatial cluster representing a portion of geo-enriched data in the subset of the plurality of geo-enriched data; and
providing the client device the set of spatial clusters instead of the portions of geo-enriched data in the subset of the plurality of geo-enriched data in order for the client device to render the map extent of the map comprising the set of spatial clusters and geo-enriched data other than the portions of geo-enriched data in the subset of the plurality of geo-enriched data.

10. The method of claim 9, wherein providing the client device the subset of the plurality of geo-enriched data comprises providing the client device the subset of the plurality of geo-enriched data upon determining that the clustering option indicates not to cluster the geo-enriched data.

11. The method of claim 9, wherein the clustering option specifies a threshold number of data points, wherein the method further comprises determining a number of geo-enriched data in the subset of the plurality of geo-enriched data, wherein generating the set of spatial clusters and providing the client device the set of spatial clusters are performed when the number of geo-enriched data in the subset of the plurality of geo-enriched data is greater than the threshold number of data points.

12. The method of claim 8, wherein determining the subset of the plurality of geo-enriched data comprises performing a set of spatial operations on the plurality of geo-enriched data and the map extent.

13. The method of claim 8, wherein the query is a first query, wherein the plurality of geo-enriched data is a first plurality of geo-enriched data, wherein the method further comprises:
receiving from the client device a second, different query for geo-enriched data and the map extent;
identifying a second plurality of geo-enriched data based on the second query;
storing the second plurality of geo-enriched data;
determining a subset of the second plurality of geo-enriched data based on the map extent; and
providing the client device the subset of the second plurality of geo-enriched data in order for the client device to render the map extent of the map comprising the subset of the second plurality of geo-enriched data.

14. The method of claim 8, wherein the map extent is a first map extent, wherein the subset of the plurality of geo-enriched data is a first subset of the plurality of geo-enriched data, wherein the method further comprises:
receiving from the client device the query for geo-enriched data and a second, different map extent;
determining a second subset of the plurality of geo-enriched data based on the second map extent; and
providing the client device the second subset of the plurality of geo-enriched data in order for the client device to render the second map extent of the map comprising the second subset of the plurality of geo-enriched data.

15. A system comprising:
a set of processing units; and
a non-transitory computer-readable medium storing instructions that when executed by at least one processing unit in the set of processing units cause the at least one processing unit to:
receive from a client device a query for geo-enriched data and a map extent;
identify a plurality of geo-enriched data based on the query;
store the plurality of geo-enriched data;
determine a subset of the plurality of geo-enriched data based on the map extent; and
provide the client device the subset of the plurality of geo-enriched data in order for the client device to render the map extent of a map comprising the subset of the plurality of geo-enriched data.

16. The system of claim 15, wherein the instructions further cause the at least one processing unit to:
receive from the client device a clustering option for the geo-enriched data;
upon determining that the clustering option indicates to cluster the geo-enriched data:
generate a set of spatial clusters, each spatial cluster representing a portion of geo-enriched data in the subset of the plurality of geo-enriched data; and
provide the client device the set of spatial clusters instead of the portions of geo-enriched data in the subset of the plurality of geo-enriched data in order for the client device to render the map extent of the map comprising the set of spatial clusters and geo-enriched data other than the portions of geo-enriched data in the subset of the plurality of geo-enriched data,
wherein providing the client device the subset of the plurality of geo-enriched data comprises providing the client device the subset of the plurality of geo-enriched data upon determining that the clustering option indicates not to cluster the geo-enriched data.

17. The system of claim 16, wherein the clustering option specifies a threshold number of data points, wherein the instructions further cause the at least one processing unit to determine a number of geo-enriched data in the subset of the plurality of geo-enriched data, wherein generating the set of spatial clusters and providing the client device the set of spatial clusters are performed when the number of geo-enriched data in the subset of the plurality of geo-enriched data is greater than the threshold number of data points.

18. The system of claim 15, wherein determining the subset of the plurality of geo-enriched data comprises performing a set of spatial operations on the plurality of geo-enriched data and the map extent.

19. The system of claim 15, wherein the query is a first query, wherein the plurality of geo-enriched data is a first plurality of geo-enriched data, wherein the instructions further cause the at least one processing unit to:
receive from the client device a second, different query for geo-enriched data and the map extent;
identify a second plurality of geo-enriched data based on the second query;
store the second plurality of geo-enriched data;
determine a subset of the second plurality of geo-enriched data based on the map extent; and
provide the client device the subset of the second plurality of geo-enriched data in order for the client device to render the map extent of the map comprising the subset of the second plurality of geo-enriched data.

20. The system of claim 15, wherein the map extent is a first map extent, wherein the subset of the plurality of geo-enriched data is a first subset of the plurality of geo-enriched data, wherein the instructions further cause the at least one processing unit to:
receive from the client device the query for geo-enriched data and a second, different map extent;
determine a second subset of the plurality of geo-enriched data based on the second map extent; and
provide the client device the second subset of the plurality of geo-enriched data in order for the client device to render the second map extent of the map comprising the second subset of the plurality of geo-enriched data.
